(19) United States
(12) Patent Application Publication
(10) Pub. No.: US 2010/0032634 A1
(43) Pub. Date: Feb. 11, 2010

(54) GUIDE RAIL COVERS

(76) Inventor: Breck N. Johnson, San Diego, CA (US)

Correspondence Address: GREER, BURNS & CRAIN, 300 S WACKER DR, 25TH FLOOR, CHICAGO, IL, 60606, US

(21) Appl. No.: 12/579,826

(22) Filed: Oct. 15, 2009

Related U.S. Application Data
(62) Division of application No. 11/198,169, filed on Aug. 5, 2005, now abandoned.

(51) Int. Cl. E04H 17/14; G09F 19/00

(52) U.S. Cl. 256/59; 40/1

(57) ABSTRACT

Covers for the guide railings in ballparks, stadiums, arenas and other public gathering places are formed from a durable sheet material having a length approximately the same as that of a section of guide railing and a width somewhat less than twice the height of the railing. The cover is draped over the railing for covering both sides of the railing and for providing substantially increased space in ballparks, stadiums and arenas for the display of decorative, informational and/or advertising materials.

This Application is a Division of application Ser. No. 11/198,169, filed Aug. 5, 2005.

### FIELD OF THE INVENTION

The present invention relates to covers for the guide railings found in ball parks, stadiums, arenas and other places of public gathering.

### BACKGROUND OF THE INVENTION

Stadiums, arenas, ballparks and other public gathering places conventionally provide hand railings along walkways, ramps and stairs to assists patrons in going up and down stairs, to guide patrons in moving from place to place and for purposes of crowd control. State, County and City safety codes require the railings and set specifications for their construction and location. Usually, the codes call for vertical stanchions, a handrail extending between the stanchions, and a rail intermediate the top rail and the walking surface to prohibit, or at least discourage, people from going under the handrail from one side to the other.

The rails are conventionally made of pipe and are frequently unsightly and obtrusive.

### SUMMARY OF THE INVENTION

The object of the present invention is to provide functional and decorative covers for guide railings.

Another object of the invention is to provide guide rail covers bearing and/or accommodating informational messages, decorative materials, advertisements, and the like. The covers can, in particular, significantly increase the advertising space available in a ball park, stadium or arena to the benefit of advertisers, stadium and arena operators, and ultimately the patrons or fans in terms of reduced admission prices, or at least minimization of price increases.

In accordance with the invention, a railing cover is comprised of a durable sheet material, such as plastic or canvas, of a length substantially equal to or less than that of a section of railing and of a width somewhat less then twice the height of the railing, and means for securing the sheet to the railing. The sheet is draped, substantially along its center line, over the top or handrail of the railing to cover both sides of the railing, but without dragging on the adjacent walking surface. Securing means, such as loop and hook fasteners, are attached to the sheet at both ends to facilitate securing of the sheet to the vertical stanchions of the railing. Securing means may also extend between the lower edges of the draped sheet below the intermediate rail of the railing to mitigate against purposeful, inadvertent or accidental removal of the cover from the railing.

At each side of the railing, the sheet may bear decorative materials, such as decorative patterns, team colors, names, nicknames and logos, etc., and/or the sheet may bear advertisements and/or informational material, such as directions, e.g., the word “exit” and an associated arrow. Also, the sheet may be provided at one or both sides of the railing with one or more transparent pockets for reception of replaceable materials, such as one advertisement one week and a different advertisement the following week.

The cover also provides patrons a more comfortable and safe hand grip surface than a metal pipe.

The railing covers of the invention may thus enhance the decor of the stadium or arena, make attendance at events more enjoyable, and satisfy the wants and desires of stadium operators and advertisers.

These and other objects and advantages of the invention will become apparent to those of reasonable skill in the art from the following detailed description, as considered in conjunction with the accompanying drawings.

### BRIEF DESCRIPTION OF THE DRAWINGS

FIG. 1 is a side elevation of a typical guide railing for a stairway or a ramp;

FIG. 2 is a side elevation of the guide railing of FIG. 1 equipped with a cover pursuant to the invention;

FIG. 3 is a plan view of a cover made in accordance with the invention; and

FIG. 4 is an end view of the cover of FIG. 3 draped over a guide railing.

### DETAILED DESCRIPTION

The following is a detailed description of certain embodiments of the invention presently contemplated by the inventor to be the best mode of carrying out his invention.

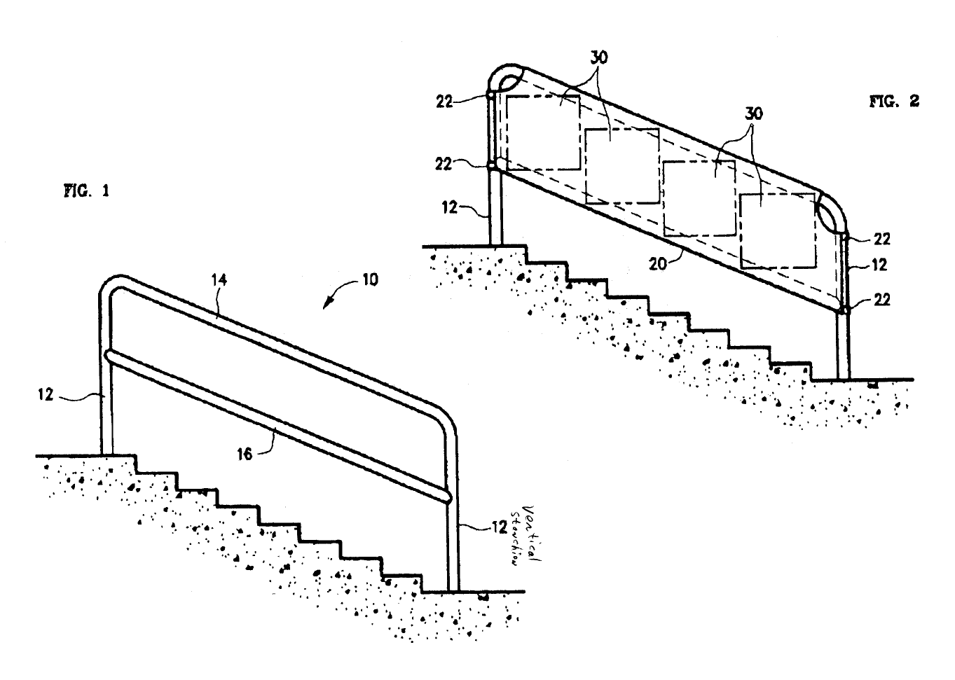

Referring to FIG. 1, a typical guide railing section 10 for a stairway or inclined ramp is comprised of at least two vertical stanchion 12, a top handrail 14 extending between and secured to the upper ends of the stanchions and a rail 16 extending between and secured to the two stanchions intermediate the ends of the stanchions. For a stairway or ramp, the rails are parallel to one another and the incline of the stairway or ramp. For a horizontal walkway, the rails 14 and 16 are horizontal and parallel to one another and the walkway.

In accordance with the invention, as illustrated in FIG. 2, a cover 20 is draped over the handrail 14 preferably to cover both sides of the railing 10 from the handrail 14 to a location at or below the intermediate rail 16 or even to the lower ends of the stanchions 12, but without dragging on the walkway, ramp or stair. The cover is secured to the stanchions by straps 22 extending around the stanchions.

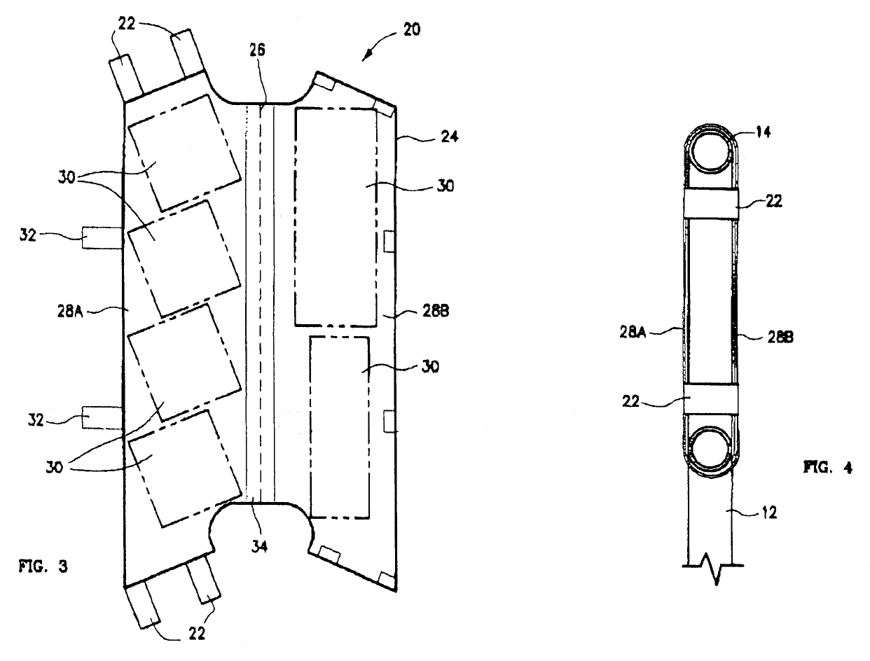

Referring to FIGS. 3 and 4, the cover 20 comprises a sheet 24 of durable material, such as plastic, canvas or the like, and for outdoor stadiums, it is preferably weatherable, i.e., rain, snow and fade resistant.

The sheet 24 is of a length corresponding approximately to the length of a railing section 10 and of a width no greater than twice the height of the railings section. In the preferred embodiment, the width of the sheet is somewhat less than twice the height of the railing and has a center, indicated by dotted line 26, so that the sheet has two sides 28a and 28b of equal width for covering respective sides of the railing 10.

The sides 28a and 28b may be directly imprinted with decorative, informational or advertising materials. Alternatively, one or more transparent pockets 30 of the same or varying sizes may be secured to one or both sides of the cover for reception of replaceable materials, such as replaceable advertisements for a variety of different products and/or services. The pockets may be arranged parallel to the side edges of the cover, which upon installation on a railing become the bottom edges of the cover, as shown in FIG. 3, or for an inclined railing may be skewed so that, upon installation of the cover on an inclined railing, the pockets appear horizontal as shown in FIG. 2.

The sides 28a and 28b are provided at each of their ends with cooperative securing means, such as straps 22 and suitable strap fastening means, preferably cooperative hook and loop fasteners provided on respective surfaces of the straps and the opposite side member 28a or 28b.

Similar straps 32 and fasteners may be provided between the side or bottom edges of the sheet for extension under the intermediate rail 16 for deterring purposeful, inadvertent or accidental removal of the cover from the railing.

The invention thus provides additional space in an arena or stadium for display of decorative, informational and advertising materials. It also affords patrons a more comfortable and safe hand grip surface than the customary metal pipe. If desired, a specifically designed hand grip surface 34 could be provided over an area along the center of the cover.

The objects and advantages of the invention have therefore been shown to be attained in a convenient, practical, economical and facile manner.

While preferred embodiments of the invention have been herein illustrated and described, it is to be appreciated that various changes, rearrangements and modifications may be made therein without departing from the scope of the invention as defined by the appended claims.

What is claimed is:

1. A combination railing and railing cover wherein
the railing comprises a pair of laterally spaced generally upright stanchions having upper and lower ends, a top rail extending between the upper ends of the stanchions and an intermediate rail extending between the stanchions intermediate the upper and lower ends thereof, and
the cover comprises a sheet draped over the top rail and extending generally from one stanchion to the other stanchion and generally from the top rail to the intermediate rail.

2. The combination of claim 1 including means on said sheet for securing the sheet to the railing.

3. The combination of claim 1 including means on said sheet for securing ends of the sheet to the stanchions and a bottom of the sheet to the intermediate rail.

4. The combination of claim 1 including a hand grip surface on a portion of said sheet overlying the top rail of the railing.

5. The combination of claim 1 including decorative, informational or advertising material on said sheet.

6. The combination of claim 1, wherein the sheet is of a length approximately equal to that of the top rail and of a width approximately equal to twice the distance between the top rail and the intermediate rail for draping over and covering both sides of the railing, from the top rail to the intermediate rail.

7. The combination of claim 6 including means at ends of said sheet for securing said sheet to the stanchions.

8. The combination of claims 6 including means at bottom edges of said sheet for securing said sheet to the intermediate rail.

9. The combination of claim 6 including first strap means at ends of said sheet for securing ends of the sheet to the stanchions and second strap means at bottom edges of said sheet for securing bottom edges of the sheet to the intermediate rail.

10. The combination of claim 6 including a safety hand gripping surface extending generally longitudinally along a central area of said sheet and overlying the top rail.

11. The combination of claim 6 including decorative, informational or advertising material on said sheet arranged for exposure on one or both sides of the railing.
